(19) United States
(12) Patent Application Publication
(10) Pub. No.: US 2008/0009299 A1
(43) Pub. Date: Jan. 10, 2008

(54) Text message management method and apparatus for mobile terminal

(75) Inventor: Ji-Youn Ryu, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS., LTD., Suwon-si (KR)

(21) Appl. No.: 11/706,854

(22) Filed: Feb. 15, 2007

(30) Foreign Application Priority Data
Jul. 5, 2006 (KR) 10-2006-0062820

(51) Int. Cl. H04Q 7/20

(52) U.S. Cl. 455/466

(57) ABSTRACT

A text message management method and apparatus for a mobile terminal are disclosed. The text message management apparatus includes a communication unit for receiving a text message; a message analyzer for analyzing the received text message to find a digit string of successive numeric digits, and regarding the found digit string as a phone number; a memory unit for storing a spam list of spam items; a comparator for comparing the digit string regarded as a phone number with spam items in the spam list; an input unit for enabling a user to input, if the digit string regarded as a phone number is not present in the spam list, a request of spam list insertion; and a controller for inserting, in response to input of a request of spam list insertion, the digit string regarded as a phone number into the spam list.

### PRIORITY

This application claims priority to an application entitled “Text Message Management Method And Apparatus For Mobile Terminal” filed in the Korean Intellectual Property Office on Jul. 5, 2006 and assigned Serial No. 2006-0062820, the contents of which are incorporated herein by reference.

### BACKGROUND OF THE INVENTION

1. Field of the Invention

The present invention relates generally to a mobile terminal and, more particularly, to a text message management method and apparatus for managing spam text messages in a mobile terminal.

2. Description of the Related Art

A mobile terminal is a wireless communication device that can be readily carried and moved by a person for communication at most times and places. A mobile terminal acting as a mobile station (MS) can freely move in service areas formed by base stations (BS) of a mobile network system to which the mobile terminal subscribes. The mobile terminal is used to make a wireless connection to a desired recipient through a communication path established by monitoring, controlling and switching operations of mobile switching centers (MSC).

While mobile terminals enable communication in motion at most times and places, they incur a relatively high communication cost and may most of the time be in a standby mode, leading to under-utilization of communication facilities.

For better utilization and effectiveness of mobile terminals at a reasonable cost, manufacturers of mobile terminals and mobile service providers continuously develop and provide functions and services related to, for example, a camera, a Bluetooth® device, a wireless local area network, radio, games, a calculator, a calendar, a clock, ring tones, text messages, image messages, on-line games, wireless Internet access, and caller identification.

In particular, text message services are widely utilized as a practical communication means. For a text message service, real-time allocation of a communication channel is unnecessary and the time duration of retaining an allocated communication channel is short, thereby reducing the communication cost. Text messages are short and can be easily stored for later use. Further, identical text messages can be simultaneously transmitted to multiple recipients.

However, unsolicited commercial or sexually offensive messages, commonly known as spam messages, may be sent to many unspecified recipients using text message services without permission of the recipients. Hence, it is necessary to provide a means for separately managing or blocking spam messages in a mobile terminal.

### SUMMARY OF THE INVENTION

The present invention has been made in view of the above problems, and an object of the present invention is to provide a method and apparatus for managing and blocking spam messages in a mobile terminal.

The present invention provides a text message management apparatus for a mobile terminal, including a communication unit for receiving a text message; a message analyzer for analyzing the received text message to find a digit string of successive numeric digits, and if a digit string is found, regarding the found digit string as a phone number; a memory unit for storing a spam list of spam items; a comparator for comparing the digit string regarded as a phone number with spam items in the spam list; an input unit for enabling a user to input, if the digit string regarded as a phone number is not present in the spam list, a request of spam list insertion; and a controller for inserting, in response to input of a request of spam list insertion, the digit string regarded as a phone number into the spam list.

In another aspect of the present invention, there is provided a text message management method for a mobile terminal, including receiving a text message; finding a digit string of successive numeric digits by analyzing the received text message, and if a digit string is found, regarding the found digit string as a phone number; comparing the digit string regarded as a phone number with pre-stored spam items of a spam list, and requesting, if the digit string regarded as a phone number is not present in the spam list, a user to decide whether to save the digit string in the spam list; and inserting, if the user decides to save the digit string, the digit string regarded as a phone number into the spam list as a spam item.

In a feature of the present invention, a received text message is analyzed and a digit string considered as a phone number is found and, if requested by a user, registered in a spam list. When a new text message containing a digit string or a phone number registered in the spam list is received, the text message is automatically moved into a spam message box, thereby blocking spam text messages.

### BRIEF DESCRIPTION OF THE DRAWINGS

The above and other objects, features and advantages of the present invention will be more apparent from the following detailed description in conjunction with the accompanying drawings, in which:

FIG. 1 illustrates a configuration of a mobile terminal having a text message management function according to the present invention;

FIG. 2 illustrates an example format of a text message received by the mobile terminal of FIG. 1;

FIG. 3 is a flow chart illustrating the steps of a text message management method according to the present invention;

FIGS. 4A and 4B are flow charts illustrating the step in the method of FIG. 3 of inserting a digit string into a spam list;

FIGS. 5A to 5D illustrate display screen representations of a first example of spam message management by the method of FIG. 3; and

FIGS. 6A to 6C illustrate display screen representations of a second example of spam message management by the method of FIG. 3;

### DETAILED DESCRIPTION OF PREFERRED EMBODIMENTS

Hereinafter, preferred embodiments of the present invention are described in detail with reference to the accompanying drawings. The same reference symbols identify the same or corresponding elements in the drawings. Some constructions or processes known in the art may be not described to avoid obscuring the invention in unnecessary detail.

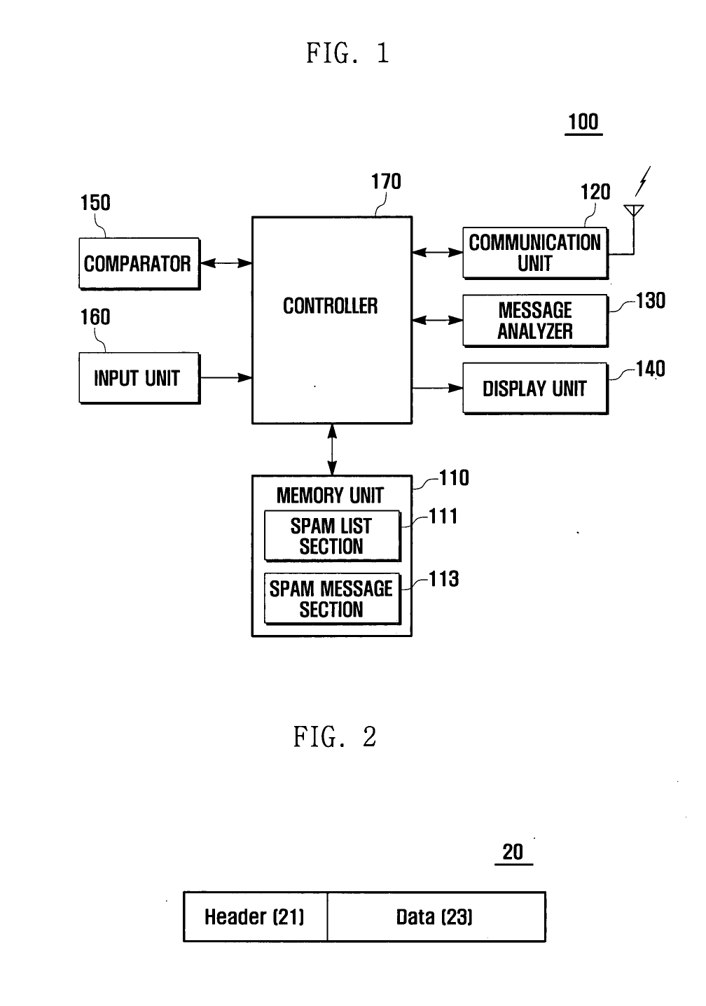

Referring to FIG. 1, the mobile terminal 100 includes a memory unit 110, a communication unit 120, a message analyzer 130, a display unit 140, a comparator 150, an input unit 160, and a controller 170.

Memory unit 110 stores programs and related data necessary for the operation of mobile terminal 100 and for the control operation of controller 170, and may be composed of various memory devices such as an erasable programmable read only memory (EPROM), static random access memory (SRAM) and flash memory. In particular, memory unit 110 includes a spam list section 111 for storing a spam list composed of spam items, and a spam message section 113 having a spam message box for storing spam messages.

Communication unit 120 transmits and receives voice data and control data to and from a corresponding base station through wireless communication. Communication unit 120 receives a call from a calling mobile terminal through an antenna and sends the received call to controller 170, and transmits data stored in memory unit 110 through the antenna to a called mobile terminal. In particular, communication unit 120 receives incoming text messages using a short message service (SMS), long message service (LMS), and multimedia message service (MMS).

Message analyzer 130 analyzes a text message received through communication unit 120 to find a digit string, preferably composed of at least three successive numeric digits. If a digit string is found in the received text message, message analyzer 130 regards the found digit string as a phone number. For example, if a digit string ‘0801111111’ is found in a received text message, message analyzer 130 regards the digit string ‘0801111111’ as a phone number.

Further, if a combination of a special character such as ‘#’, ‘-’, ‘*’, ‘(’ or ‘)’ and numeric digits is found in a received text message and if the number of the numeric digits in the combination is greater than a preset value, the message analyzer 130 regards the digit string composed of the numeric digits after the special character in the combination as a phone number.

Display unit 140 displays operating modes and states of mobile terminal 100. In particular, display unit 140 displays a received text message. Preferably, during display of a text message, display unit 140 puts a visual mark on a digit string that is regarded as a phone number by message analyzer 130, for a subsequent operation, by, for example, placing a cursor or a highlight on the digit string.

Comparator 150 compares the digit string regarded as a phone number by message analyzer 130 with spam items of the spam list. A spam item is a criterion, preferably a particular character string or phone number, for determination of a spam message.

Input unit 160 may include various devices such as a keypad and touch screen, and is used by the user to select a desired function or to input desired information. In particular, if a digit string that is regarded as a phone number by message analyzer 130 is determined, by the comparator 150, not to be present in the spam list, input unit 160 asks the user to decide whether to insert the digit string into the spam list, and receives a corresponding user selection.

Controller 170 controls overall operation and states of mobile terminal 100, and may include a microprocessor or digital signal processor (DSP). In particular, if a digit string in a received message that is regarded as a phone number by message analyzer 130 is determined not to be present in the spam list, controller 170 inserts the digit string into the spam list or transmits the received message as a rejected message using a selected recipient phone number, according to a user selection through input unit 160.

If a digit string in a received message that is regarded as a phone number by message analyzer 130 is determined to be present in the spam list, controller 170 regards the received message as a spam message and stores the received message in memory unit 110, preferably in the spam message box stored in spam message section 113. Controller 170 may also delete the received message regarded as a spam message for effective use of a storage area of memory unit 110.

Preferably, controller 170 puts a visual mark on a digit string in a received message that is regarded as a phone number. The controller inserts the digit string into the spam list, if the user inputs a menu key and selects a menu item of spam list insertion after displaying the menu items in response to the menu key input.

Alternatively, if the user selects a menu item related to a call connection, controller 170 makes a call using the digit string as a recipient phone number. When the user inputs a call termination command, controller 170 terminates the call. Further, in response to selection of the menu item of call connection, controller 170 controls display of call related menu items, and inserts, if the user selects a menu item of message rejection, the digit string into the spam list in spam list section 111.

Preferably, controller 170 controls display unit 140 to display a pop-up window for requesting the user to decide whether to insert a digit string regarded as a phone number into the spam list.

Referring to FIG. 2, text message 20 includes a header field 21 and a data field 23. Header field 21 is used to store recipient/sender information (for example, a sender phone number and recipient phone number) and transmission time information. Data field 23 is used to store text data composed by a sending user. The length of data field 23 may vary (for example, 80 or 90 bytes) depending upon mobile network operators.

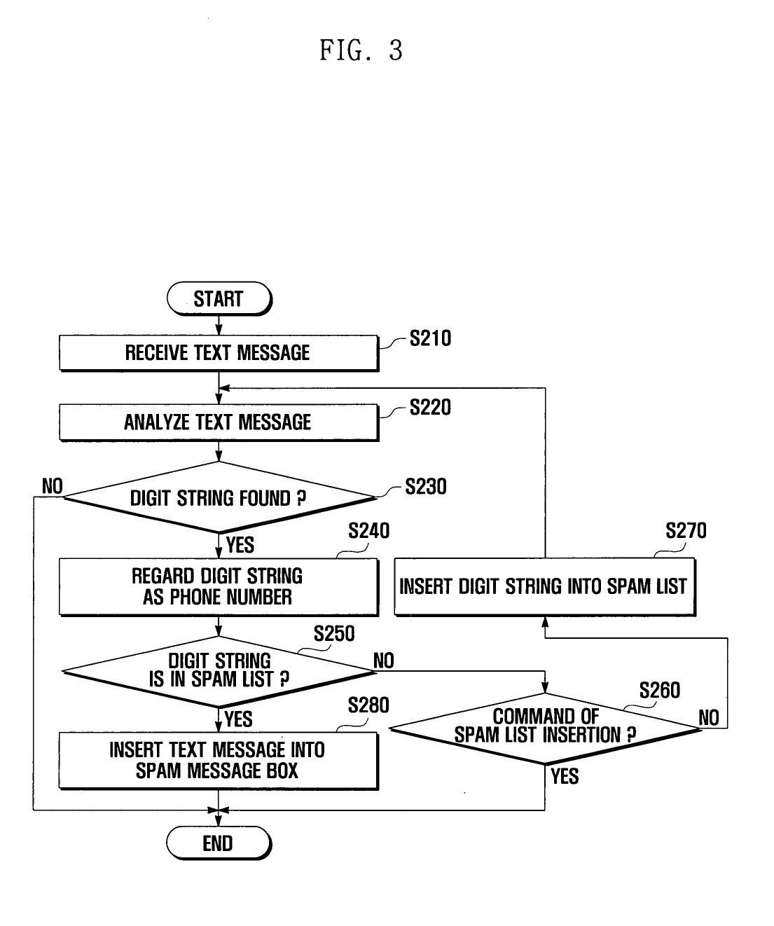

Referring to FIGS. 1 and 3, the method is described below.

Controller 170 controls communication unit 120 to receive an incoming text message in step S210. Controller 170 controls message analyzer 130 to analyze the received text message in step S220 to find a string of numeric digits, preferably at least three successive numeric digits in step S230. If a digit string (for example, ‘0801111111’) is found in the received text message, the found digit string is regarded as a phone number in step S240. In addition, preferably, if a special character such as ‘#’ or ‘*’ that may indicate a phone number is found by message analyzer 130, a digit string occurring immediately after the special character is also regarded as a phone number.

Controller 170 compares the digit string regarded as a phone number with spam items of a spam list pre-stored in spam list section 111 to determine whether the digit string is present in the spam list in step S250. If the digit string is not present in the spam list, controller 170 determines whether a command of spam list insertion is input through input unit 160 in step S260. If a command of spam list insertion is input, controller 170 inserts the digit string as a spam item into the spam list stored in the spam list section 111 in step S270.

If the digit string is determined to be present in the spam list at step S250, controller 170 regards the received text message containing the digit string as a spam message, and stores the received text message in a spam message box of the spam message section 113 in step S280. For effective use of a storage area of memory unit 110, controller 170 may delete the received text message regarded as a spam message.

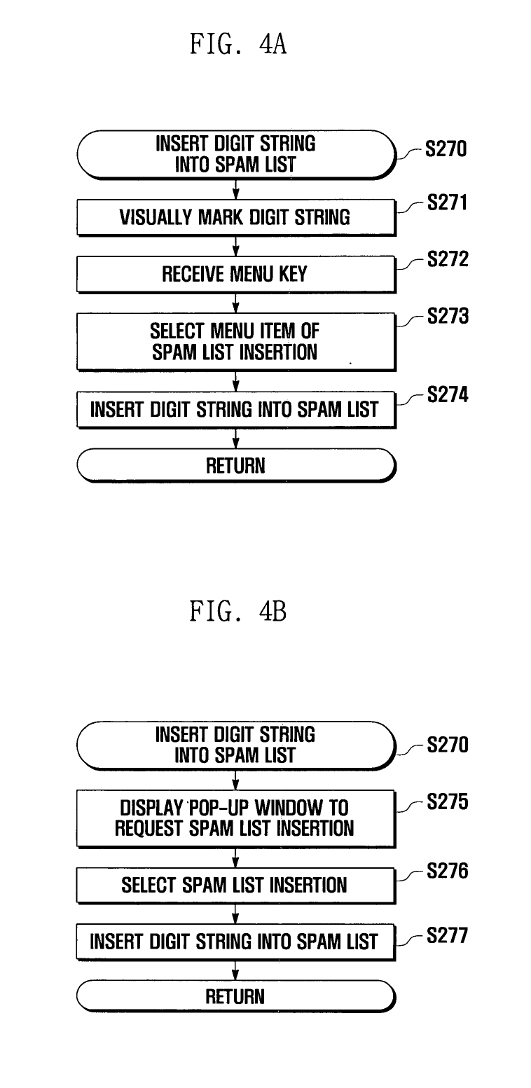

Referring to FIGS. 1 and 4A, controller 170 puts a visual mark on the digit string regarded as a phone number in the received text message in step S271. When the user inputs a menu key in step S272 and selects a menu item of spam list insertion from one or more menu items displayed in response to the menu key in step S273, controller 170 inserts the visually marked digit string into the spam list S274.

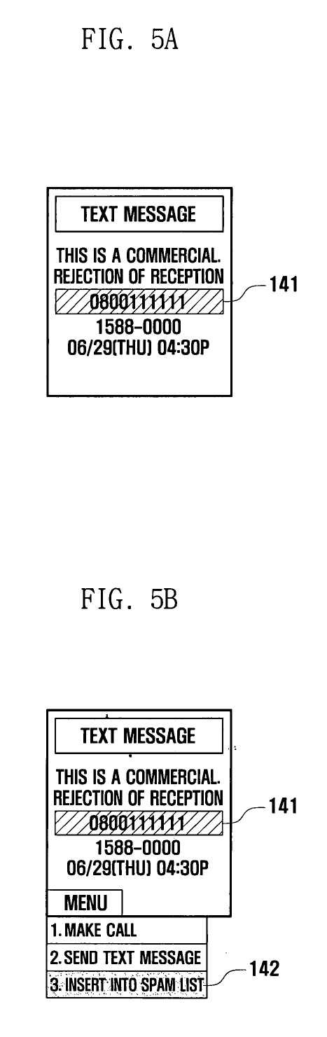

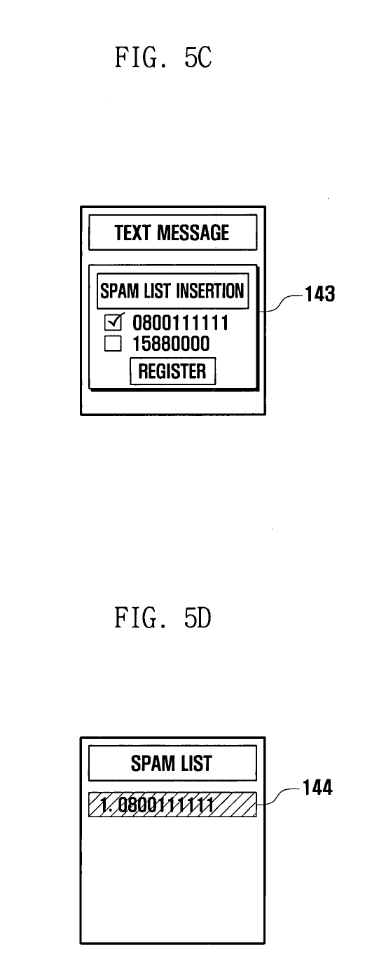

For example, controller 170 controls display of a received text message through display unit 140. Referring to FIG. 5A, if a digit string ‘0801111111’ is found by message analyzer 130, controller 170 puts a visual mark on digit string ‘0801111111’ 141. In response to a menu key input, selectable menu items are displayed, as illustrated in FIG. 5B. When the user selects a menu item of spam list insertion 142, controller 170 inserts the digit string ‘0801111111’ 141 into the spam list, as illustrated in FIG. 5D. Alternatively, as illustrated in FIG. 5C, controller 170 may create and display a list of all digit strings regarded as a phone number and found in the received text message, and the user may select one or more of the listed digit strings to be inserted into the spam list.

Referring to FIGS. 1 and 4B, after finding a digit string regarded as a phone number in the received text message, controller 170 controls display unit 140 to display a pop-up window for requesting the user to decide whether to insert the digit string into the spam list in step S275. If the user decides to insert the digit string in step S276, controller 170 inserts the digit string into spam list S277.

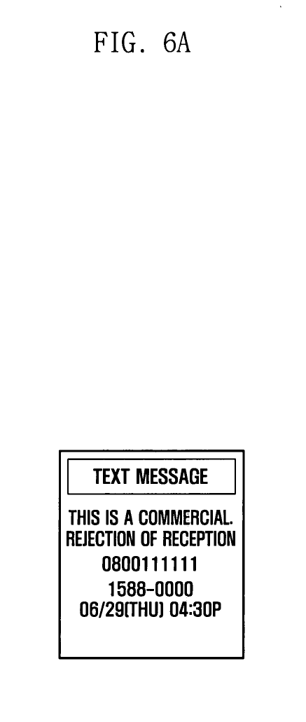

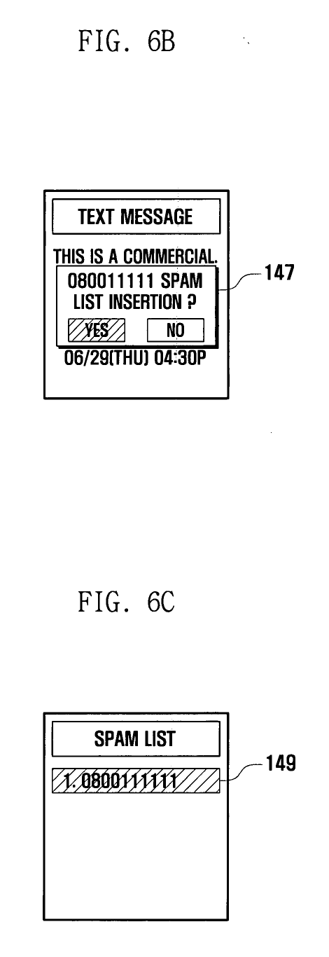

For example, referring to FIG. 6A, controller 170 controls display unit 140 to display a received text message. After finding a digit string ‘0801111111’ regarded as a phone number, controller 170 controls display unit 140 to display a pop-up window 147 for requesting the user to decide whether to insert the digit string ‘0801111111’ into the spam list, as illustrated in FIG. 6B. If the user decides to insert the digit string by selecting ‘yes’, controller 170 inserts the digit string ‘0801111111’ 149 into the spam list of spam list section 111, as illustrated in FIG. 6C.

As apparent from the above description, the present invention provides a text message management method and apparatus for a mobile terminal wherein a received text message is analyzed and a digit string considered as a phone number is found and registered in a spam list if requested by a user. When a new text message containing a digit string or a phone number registered in the spam list is received, the text message is automatically moved into a spam message box. As a result, spam text messages are conveniently blocked.

While preferred embodiments of the present invention have been shown and described in this specification, it will be understood by those skilled in the art that various changes or modifications of the embodiments are possible without departing from the spirit and scope of the invention as further defined by the appended claims.

What is claimed is:

1. A text message management apparatus for a mobile terminal, comprising:
a communication unit for receiving a text message;
a message analyzer for analyzing the received text message and if a digit string is found, regarding the found digit string as a phone number;
a memory unit for storing a spam list of spam items;
a comparator for comparing the digit string regarded as the phone number with spam items in the spam list;
an input unit for enabling a user to input if the digit string regarded as a phone number is not present in the spam list, a request of spam list insertion; and
a controller for inserting the digit string regarded as a phone number into the spam list in response to the input request.

2. The text message management apparatus of claim 1, wherein the digit string of successive numeric digits regarded as a phone number is composed of at least three successive numeric digits.

3. The text message management apparatus of claim 1, wherein the controller regards the received text message as a spam message if the digit string regarded as a phone number is present in the spam list and allowing a user to request insertion of the message in the spam list.

4. The text message management apparatus of claim 3, wherein the controller controls storage of the received text message regarded as a spam message in a spam message box.

5. The text message management apparatus of claim 3, wherein the controller removes the received text message regarded as a spam message.

6. The text message management apparatus of claim 1, wherein the message analyzer regards, if a combination of a special character and a digit string is found in the received text message, the digit string immediately after the special character as a phone number.

7. The text message management apparatus of claim 1, wherein the controller controls display of a visual mark on the digit string regarded as a phone number, controls display of selectable menu items in response to input of a menu key, and inserts, if a spam list insertion menu item is selected by the user, the digit string into the spam list.

8. The text message management apparatus of claim 1, wherein the controller controls a display unit to display a pop-up window for requesting the user to decide whether to insert the digit string regarded as a phone number into the spam list.

9. A text message management method for a mobile terminal, comprising:
receiving a text message;
finding a digit string of successive numeric digits by analyzing the received text message, and regarding, if a digit string is found, the found digit string as a phone number;
comparing the digit string regarded as a phone number with pre-stored spam items of a spam list, and requesting, if the digit string regarded as a phone number is not present in the spam list, a user to decide whether to save the digit string in the spam list; and
inserting, if the user decides to save the digit string, the digit string regarded as a phone number into the spam list as a spam item.

10. The text message management method of claim 9, wherein the digit string regarded as a phone number is composed of at least three successive numeric digits.

11. The text message management method of claim 9, further comprising regarding the received text message as a spam message if the digit string regarded as a phone number is present in the spam list.

12. The text message management method of claim 11, further comprising storing the received text message regarded as a spam message in a spam message box.

13. The text message management method of claim 11, further comprising removing the received text message regarded as a spam message.

14. The text message management method of claim 9, wherein in the finding a digit string step, if a combination of a special character and a digit string is found, the digit string immediately after the special character is regarded as a phone number.

15. The text message management method of claim 9, wherein the inserting the digit string step comprises:
displaying a visual mark on the digit string regarded as a phone number;
displaying, in response to input of a menu key, selectable menu items; and
inserting, if a spam list insertion menu item is selected by the user, the digit string into the spam list.

16. The text message management method of claim 9, wherein the inserting the digit string step comprises:
displaying a pop-up window for requesting the user to decide whether to save the digit string in the spam list; and
inserting, if the user decides to save the digit string, the digit string into the spam list.
